(19) United States
(12) Patent Application Publication
(10) Pub. No.: US 2006/0137192 A1
(43) Pub. Date: Jun. 29, 2006

(54) Upright manual shears

(75) Inventor: Stephen D. Deter, Sturgis, MI (US)

Correspondence Address: KREMBLAS, FOSTER, PHILLIPS & POLLICK, 7632 SLATE RIDGE BOULEVARD, REYNOLDSBURG, OH, 43068, US

(73) Assignee: Midwest Tool And Cutlery Company

(21) Appl. No.: 11/024,080

(22) Filed: Dec. 28, 2004

(51) Int. Cl. B26B 13/00

(52) U.S. Cl. 30/248

(57) ABSTRACT

Cutting shears having a pair of handles pivotally connected as levers to a lower pivot and pivotally connected in a compound linkage arrangement to a pair of intersecting cutting blades at an upper pivot. A hand grip on each of the handles includes an outwardly projecting upper hand grip tab and the distance from the upper pivot to a hand contacting surface of each upper hand grip tab is substantially in the range from 2½″ to 3¼″ and preferably substantially 2¾″. The distance from the locus of intersections of the blades as they pivot through a cutting motion to the plane of the most distal tips of the handles is substantially within range from 6¾″ to 7¼″ and preferably 7″. The hand grips are substantially identically, arcuately, outwardly, oppositely contoured and longitudinally symmetrical. Each hand grip also has an outwardly projecting lower hand grip tab and the hand contacting surfaces of the upper and lower tabs on each hand grip are spaced apart a distance substantially 4½″ although they may be substantially within the range of 4¼″ to 4¾″. The tabs protrude outwardly from an intermediate portion of the hand grips preferably by ½″.

### BACKGROUND OF THE INVENTION

1. Field of the Invention

This invention relates generally to hand tools and more particularly to cutting tools known in the art as shears or snips which utilize a levered, scissors action for cutting sheet stock such as sheet metal.

2. Description of the Related Art

An extensive variety of shears of this type have been developed over many decades. Such shears are hand operated and have a pair of handles attached to a pair of blade and having one or more pivotal connections as levers. In many such shears a spring urges the handles apart to an ungripped state so the user needs merely to relax the user's hand to allow the shears to open before making the next cut. They are commonly provided with a latch for storing them is a closed position.

More recent shears have a pair of handles pivotally connected as levers to a lower pivot and pivotally connected in a compound linkage arrangement to a pair of intersecting cutting blades pivotally connected to an upper pivot. The compound linkages are used on such tools to provide an additional mechanical advantage and permit a greater force to be applied to the workpiece upon squeezing of the handles by a human operator. With such compound linkages, the distance the cutting edges move is considerably less than the distance the handles move but the additional leverage provided by the linkage applies a much greater force to the workpiece than is applied with simple levered tools.

An even more recent development is the upright, angled or right angle shears such as those illustrated, for example, in U.S. Pat. No. Des. 255,980 and U.S. Patent Application Pub. No. 2002/0138990. Upright means that the locus of the intersections of the two blades as they move through a cutting motion is transverse to the axis of symmetry of the handles, and preferably at approximately 90°. This permits the handles of the shears to project generally perpendicularly to the sheet material being cut rather than generally parallel to that sheet. This upright configuration allows the handles and the operator's hand to be positioned outwardly from the face or surface of the sheet being cut rather than inline with the cut so the operator can more easily and more comfortably manipulate the shears, especially in a work environment in tight or small spaces with limited workspace and clearance.

Although the prior art shows many structural features for shears of this type, there is a need for refinements and for dimensional optimization to make the shears more comfortable and effective to use and to permit more accurate control of the cut being made, especially in spatially limited workspaces, without sacrificing mechanical leverage and operability. For example, shears are used not only to cut straight lines and gradual curves but also are used to cut tight curves and relatively small circles. A typical use where these capabilities are valuable is cutting metal duct work and associated components for heating, air conditioning and ventilation systems in buildings. Often this work requires reaching into places of limited accessibility where a user must make cuts while reaching overhead or down in an uncomfortable posture to make cuts within close tolerances while the user's hand and the tool are confined to small spaces that permit only limited movement. Consequently there are ergonomic and size factors that play an important role in the effectiveness, comfort and convenience of the tool's use. It is not surprising that the design of the size, shape and positioning parameters of modem shears requires balancing or engineering tradeoffs of important but opposing factors in order to optimize the design of the shears.

It is therefore an object and feature of the present invention to provide a shears that optimizes these design and use considerations.

### BRIEF SUMMARY OF THE INVENTION

The invention is a pair of cutting shears having a pair of handles pivotally connected as levers to a lower pivot and pivotally connected in a compound linkage arrangement to a pair of intersecting cutting blades at an upper pivot. A hand grip on each of the handles has an outwardly projecting upper hand grip tab and the distance from the upper pivot to a hand contacting surface of each upper hand grip tab is substantially in the range from 2½″ to 3¼″ and preferably substantially 2¾″. The distance from the locus of intersections of the blades as they pivot through a cutting motion to the plane of the most distal tips of the handles is preferably substantially within range from 6¾″ to 7¼″ and most preferably 7″. The hand grips are preferably substantially identically, arcuately, outwardly, oppositely contoured and longitudinally symmetrical. Each hand grip also has an outwardly projecting lower hand grip tab and the hand contacting surfaces of the upper and lower tabs on each hand grip are preferably spaced apart a distance substantially within the range of 4¾″ to 5″ and most preferably 4⅞″. The tabs preferably protrude outwardly from an intermediate portion of the hand grips by ½″.

### BRIEF DESCRIPTION OF THE SEVERAL VIEWS OF THE DRAWINGS

FIG. 1 is a view in perspective of a right hand version of a shears embodying the present invention.

FIG. 2 is a view in perspective of the shears of FIG. 1 showing the opposite side of the shears.

FIG. 3 is a view in front elevation of the shears of FIG. 1.

FIG. 4 is a view in front elevation of a left handed version of a shears embodying the invention.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

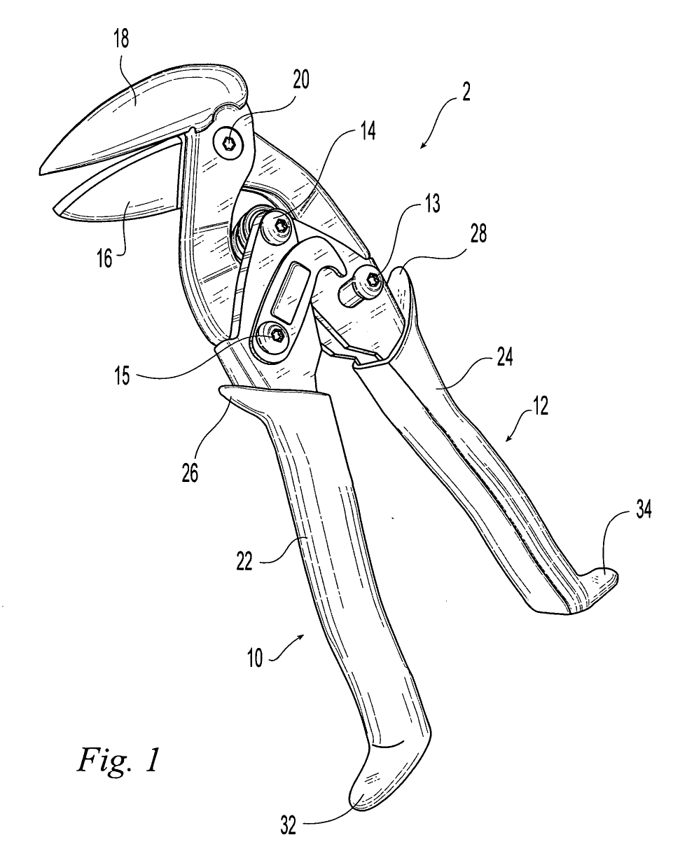

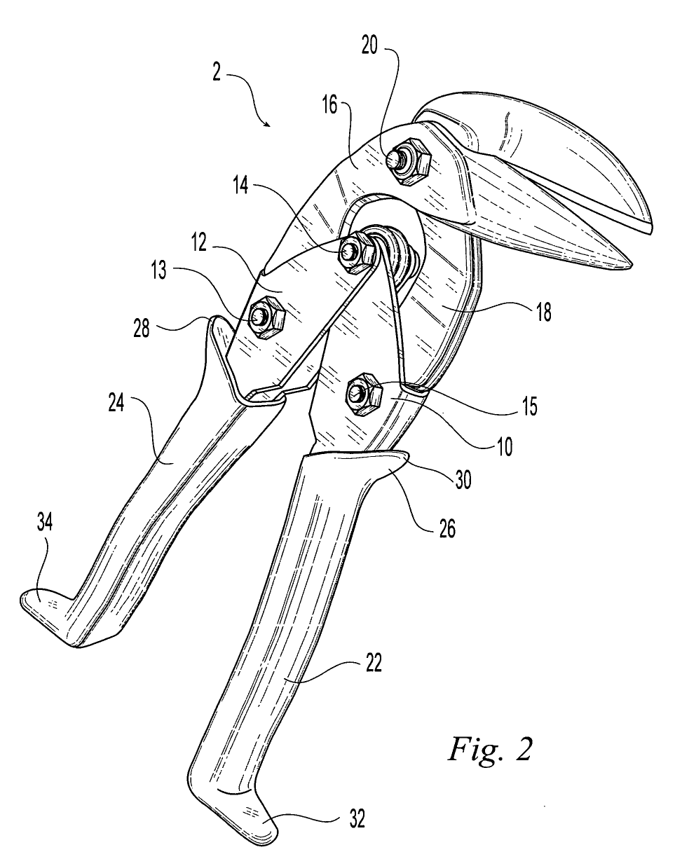

FIGS. 1-4 illustrate the preferred embodiment of the hand operated, cutting shears of the invention. The shears 2 of FIGS. 1-3 are straight and right cut shears while the shears of FIG. 4 are straight and left cut shears, the difference being the relative positioning of the top and bottom blades to the left or right of the user when they are gripped in the same orientation. However, the left and right cut variations do not affect the principles of the present invention. The shears have a pair of handles 10 and 12 pivotally connected as levers to a lower pivot 14. The handles 10 and 12 are also connected at pivots 13 and 15 in a compound linkage arrangement to a pair of intersecting cutting blades 16 and 18. The cutting blades are pivotally connected together at an upper pivot 20.

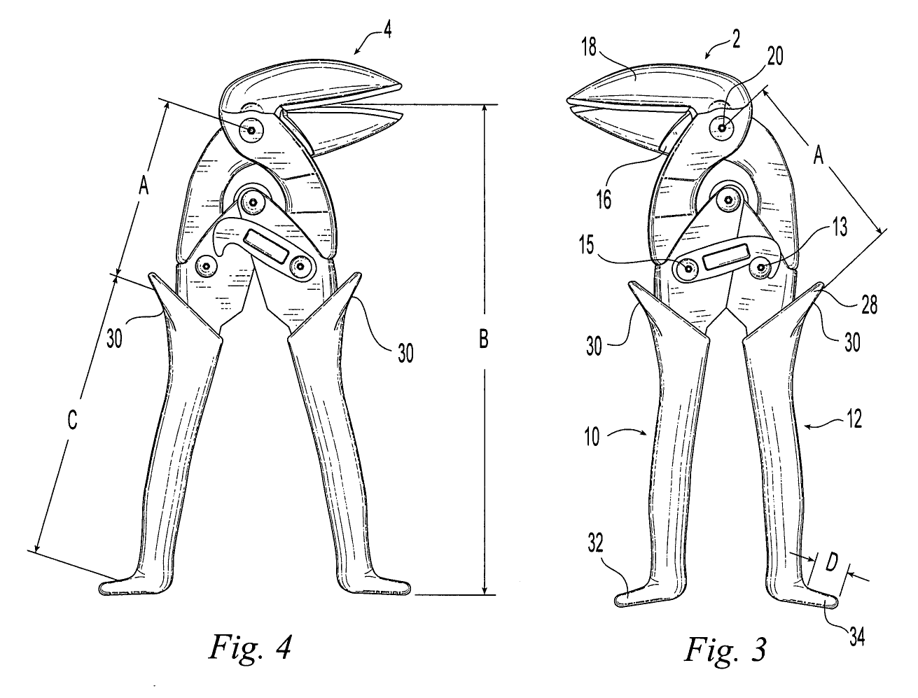

Hand grips 22 and 24 are formed on and envelope each of the handles 10 and 12 distally from the lower pivot 14. Each hand grip 22 and 24 includes an outwardly projecting upper hand grip tab, 26 and 28 respectively, near the end of the hand grip that is proximal to the lower pivot 14. A feature of the invention is that the distance A, illustrated in FIGS. 3 and 4, from the upper pivot 20 to a hand contacting surface of each upper hand grip tab, 26 and 28 respectively, is substantially in the range from 2½″ to 3¼″. Most preferably the distance A is 2¾″. The hand contacting surface is the surface of the tab that faces the center of the hand grip where the user's hand is placed to grip the handles during operation.

This dimension for the distance A moves the operator's hand position closer to the upper pivot and therefore closer to the blade cutting edges than prior art, upright, metal cutting shears. This feature both allows more accurate control of the tool by the operator during a cutting operation and also permits the handles to be shorter. Typical prior art upright shears have a distance A of 3½″. Positioning the hand grip closer to the upper pivot 20 requires a critical balancing or tradeoff between two important operational characteristics. First, as the distance A becomes shorter, the shears become movable to the desired cutting position and direction with more precision and this facilitates cutting curves and circles. Second, however, a shorter distance A also results in less leverage, therefore requiring more hand pressure, and also reduces the bite. Bite is the length of the cut that can be made comfortably with normal human hand strength and motion. In other words, a shorter distance A is better for maneuvering and a longer distance A is better for leverage and bite. I have found that the distance A described above provides an optimal combination of maneuverability, leverage and bite because it insignificantly sacrifices leverage and bite while enhancing maneuverability.

Another important characteristic of upright shears is the overall operational length. The operational length of the shears in not the total length of the tool. Instead, operational length is the distance from the “pinch”, that is from the locus of intersections of the blades as the blades pivot through a cutting motion, to the plane of the tips of the ungripped handles. Operational length is important because the shears are often used in tight spaces under conditions of small clearance. The clearance required to operate the tool is the distance from the material being cut to an object that would interfere with the positioning or motion of the handles. Since the material is located along the locus of the blade intersections during a cut, the clearance required by the shears is the distance from that locus to the most distal tips of the shears.

Finding the optimal operational length for the shears also involves determining the most desired balance between the loss of leverage and bite and the gain of clearance that result from shortening the handle length. By making the handles shorter, less clearance is required to allow the tool to be positioned and operated in tight spaces that conventional shears can not reach. However, to be operated, the tool needs to be long enough to fit a large man's hand and provide sufficient the leverage to cut the material with reasonable comfort. I have found that the optimal operational length, illustrated in FIG. 4 as dimension B, is within the range from 6¾″ to 7¼″ and most preferably is 7″. This gives a 7½″ distance from pinch to the tips of the handles when the shears are gripped and the handles are pivoted toward each other to an entirely closed position, as they are during a part of a cutting operation. The effectiveness of this operational length B can be seen, for example, from considering that, although floor joists are typically constructed 2″×10″ or 2″×12″ lumber, some are the minimum 2″×8″. In the latter case, the distance from the bottom of a subfloor to the top of an HVAC duct provides about 7½″ as the workspace height for cutting a tap into the duct. Thus, I have found that, while the nominal overall length of the preferred embodiment of the invention is about 7¾″, that is acceptable if the operational length B is within the dimensional parameters of the invention which are described above.

The operational length B is a function in part of the distance A, as can be seen in FIG. 4. Reducing distance A reduces the operational length B. Consequently, selecting the distance A to be within the range of the invention not only helps accomplish the advantages of doing so that were described above, but also helps reduce the operational length B which determines the clearance required by shears. This then leaves more handle length available for being grasped by the user's hand.

The hand grips 22 and 24 on the handles 10 and 12 of the shears are very important to the effectiveness and desirability of the shears because that is where the tool meets the user. Although arcuate hand tool handles are well know in the prior art, both of the grips 22 and 24 have a substantially identical, outwardly and oppositely directed arcuate or convex contour along their entire length except for their tab portions. Preferably the grips are also longitudinally symmetrical; that is, the upper half of the grip is essentially a mirror image of the lower half. Of course these characteristics of the hand grips are only necessary with respect to the hand engageable surfaces of the grips so it is not necessary that either the interfacing surfaces of the opposite hand grips or the surfaces of the tabs that are not contacted by the user's hand be identical, but they preferably are.

Forming the hand grips with oppositely identical contours has the advantage that the tool feels the same in the user's hand whether the blades are oriented to point toward or away from the user to make cuts toward or away from the user. Users commonly change between these blade orientations and also change between left and right hands. The handle grips feel the same to the operator whether cutting toward or away from the operator and whether using the left or right hand. The operator can shift the hand from left to right or vice versa and/or can shift the direction of approach to the opposite direction and yet the handles are gripped and feel identical for all positions or directions of approach. For example, when cutting a circle, the operator can cut the complete circle without changing hands, moving the material or changing the location of the operator or tool. Instead, the operator changes between a first position pushing the shears away from the operator while squeezing and pivoting the handles to extend the cut away from the operator and a second position pulling the shears toward the operator while squeezing and pivoting the handles to extend the cut toward the operator.

Forming the grips so that they are longitudinally symmetrical has the advantage that the tool feels the same in the user's hand whether the blades are above or below the user's hand while the cut is being made. The user can cut with the user's hand below the blades and sheet for overhead work and with the user's hand above the blades and sheet for waist or floor level work. Having the identical feel in any orientation or position of the tool is not only important for user comfort, but this standardized feel allows the user to develop through experience more precise and skillful control of the tool because the tool always feels like the same tool and therefore can be expected to always respond the same to the same physical manipulation.

In addition to the upper hand grip tabs 26 and 28 described above, each hand grip also has an outwardly projecting lower hand grip tab, 32 and 34 respectively, near the end of the hand grip 10 and 12 respectively; that is distal to the lower pivot. The tabs not only guide the operators hand onto the grip surface, but they also assist in maneuvering the shears up and down and help prevent the operator from dropping the shears during a relaxation of his grip. If the operator's grip becomes so loose that the shears slip, such as when reversing the direction of approach to the shears, the tabs contact the side of the hand and act as a stop. These tabs should be far enough apart to accommodate a large hand yet short enough to fit on the shorter handles and allow the other components freedom to move without obstruction. It is important that there be tabs on both ends of each hand grip. This provides the same assistance in raising and lowering the shears and the same protection against dropping the shears when the user's grip is relaxed whether the blades are positioned above or below the user's hand. Having the tabs at both ends also allows the tabs to feel and otherwise function the same regardless of the orientation or position of the user's grasp of the tool.

The hand contacting surfaces of the upper tabs, 26 and 28 respectively, and lower tabs, 32 and 34 respectively, on each hand grip are preferably spaced apart a distance C, illustrated in FIG. 4, that is substantially 4½″ although they may be substantially within the range of 4¼″ to 4¾″.

The tabs 26, 28, 32 and 34 should protrude outwardly from the intermediate, arcuate, hand contact surface forming the segment of the hand grip between the tabs by a protrusion distance D, illustrated in FIG. 3, that is preferably ½″ but should be at least 4¼″ to be effective.

While certain preferred embodiments of the present invention have been disclosed in detail, it is to be understood that various modifications may be adopted without departing from the spirit of the invention or scope of the following claims.

1. An improved, hand operated, cutting shears having a pair of handles pivotally connected as levers to a lower pivot and pivotally connected in a compound linkage arrangement to a pair of intersecting cutting blades pivotally connected to an upper pivot, the improvement comprising:
(a) a hand grip on each of the handles positioned distally from the lower pivot, each hand grip including an outwardly projecting upper hand grip tab near the end of the hand grip that is proximal to the lower pivot; and
(b) the distance from the upper pivot to a hand contacting surface of each upper hand grip tab being substantially in the range from 2½″ to 3¼″.

2. A shears in accordance with claim 1 wherein the distance from the upper pivot to a hand contacting surface of each upper hand grip tab is substantially 2¾″.

3. A shears in accordance with claim 1 wherein the distance from the locus of intersections of the blades as they pivot through a cutting motion to the plane of the most distal tips of the handles is substantially within range from 6¾″ to 7¼″.

4. A shears in accordance with claim 3 wherein the distance from said locus to said plane is substantially 7″.

5. A shears in accordance with claim 1 wherein the hand grips are substantially identically, arcuately, outwardly, oppositely contoured.

6. A shears in accordance with claim 5 wherein the grips are longitudinally symmetrical.

7. A shears in accordance with claim 1 wherein each hand grip also has an outwardly projecting lower hand grip tab near the end of the hand grip that is distal to the lower pivot and wherein hand contacting surfaces of the upper and lower tabs on each hand grip are spaced apart a distance substantially within the range of 4¼″ to 4¾″.

8. A shears in accordance with claim 7 wherein the tabs protrude outwardly from an intermediate portion of the hand grips by at least ¼″.

9. A shears in accordance with claim 8 wherein the upper and lower tabs on each hand grip are spaced apart a distance of substantially 4½″.

10. A shears in accordance with claim 9 wherein the tabs protrude outwardly from an intermediate portion of the hand grips by substantially ½″.

11. A shears in accordance with claim 1 wherein:
(a) the distance from the locus of intersections of the blades as they pivot through a cutting motion to the plane of the most distal tips of the handles is substantially within range from 6¾″ to 7¼″;
(b) the hand grips are substantially identically, arcuately, outwardly, oppositely contoured; and
(c) each hand grip also has an outwardly projecting lower hand grip tab near the end of the hand grip that is distal to the lower pivot and wherein hand contacting surfaces of the upper and lower tabs on each hand grip are spaced apart a distance substantially within the range of 4¼ to 4¾″.

12. A shears in accordance with claim 11 wherein:
(a) the distance from the upper pivot to a hand contacting surface of each upper hand grip tab is substantially 2¾″;
(b) the distance from said locus to said plane is substantially 7″;
(c) the grips are longitudinally symmetrical;
(d) the upper and lower tabs on each hand grip are spaced apart a distance of substantially 4½″; and
(e) the tabs protrude outwardly from an intermediate portion of the hand grips by substantially ½″.
